(19) United States
(12) Patent Application Publication
(10) Pub. No.: US 2003/0057286 A1
(43) Pub. Date: Mar. 27, 2003

(54) Passport with anti-counterfeit ID chip

(75) Inventors: Norikazu Yamagishi, Yokohama-shi (JP); Mutsuharu Takesada, Yokohama-shi (JP); Takaaki Habara, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co., Ltd.

(21) Appl. No.: 10/237,354

(22) Filed: Sep. 6, 2002

(30) Foreign Application Priority Data
Sep. 26, 2001 (JP) 2001-293200

(51) Int. Cl. G06K 19/06

(52) U.S. Cl. 235/492

(57) ABSTRACT

A passport 1 with an anti-counterfeit ID chip comprises a passport body 2 that certifies the identity and nationality of the passport holder traveling to a foreign country. The passport body 2 has embedded therein a micro ID chip 3 that records passport ID data. The ID chip 3 has stored therein various passport ID data. The ID chip 3 will not be damaged even if the chip embedded in the passport body 2 is bent. The memory capacity of the ID chip 3 is large, enabling much passport ID data to be stored therein. The ID chip 3 effectively prevents passport counterfeit.

### FIELD OF THE INVENTION

The present invention relates to a passport with an anti-counterfeit ID chip having an ID chip storing various passport ID data embedded in a passport body so as to prevent counterfeit.

### DESCRIPTION OF THE RELATED ART

In general, a passport is a document that certifies the identity and the nationality of the passport holder that travels to a foreign country and returns therefrom, asks for protection of the passport owner and requests for availability of facilities for the passport holder.

Those not in possession of a passport issued by the foreign minister or consul are prohibited from embarkation and disembarkation.

The conventional passport merely has the passport owner's personal information, passport information, photograph and the like printed on the passport body.

Recently, however, counterfeit passports have become cleverer, and in the case of Japan, the number of foreigners trying to enter the country using a cunningly forged passport has rapidly increased. Along with such trend, the number of crimes caused by illegal aliens within the country has also increased.

Currently, when a traveler travels to or returns from a foreign country, he or she presents his/her passport at the embarkation/disembarkation check gate at the airport. The officer at the embarkation/disembarkation check gate simply visually confirms the information printed on the passport such as the personal information, the passport information and the photograph so as to determine whether the passport is a counterfeit passport or not, so the check performed by the officer at the check gate is not strict enough, and it is difficult to clamp down on illegal immigrants etc. at the embarkation/disembarkation check gate of the airport.

### SUMMARY OF THE INVENTION

The object of the present invention is to solve the problems of the prior art by providing a passport with an anti-counterfeit ID chip. The present passport comprises a micro ID chip embedded in the passport body, the ID chip storing various passport ID data. The ID chip will not break even when the passport body is bent or folded. The chip is capable of storing a large amount of passport ID data. By having the chip embedded into the passport body, the counterfeiting of passport is prevented. The passport ID data stored in the ID chip can be read using a dedicated ID chip reader and the data can be displayed on a screen, so the officers at the embarkation/disembarkation check gate can visually confirm the passport ID data stored in the ID chip and displayed on the screen in addition to checking the conventional personal information, passport information, photograph etc. printed on the passport body in order to determine whether the passport is a counterfeit passport or not. Thus, it becomes possible for officers at the airport to check counterfeit passports strictly at the check gate, and to clamp down on illegal immigrants etc. using the counterfeit passports at the check gate.

The passport with an anti-counterfeit ID chip according to the present invention for certifying the identity and nationality of a passport owner traveling to and returning from a foreign country comprises a passport body, and one or more micro ID chips storing passport ID data embedded in the passport body.

According to the passport with an anti-counterfeit ID chip of the present invention, the passport ID data stored in the ID chip includes the passport owner's nationality, name, sex, registered domicile, birthday, height, current address, contact address, hair color, eye color, supplementary information, passport issue date, passport expiration date and passport number.

According to the present passport with an anti-counterfeit ID chip, the number of ID chips embedded in the passport body can be one or more than one.

According further to the present passport with an anti-counterfeit ID chip, the ID chip(s) is embedded in either the front cover or the back cover of the passport body.

According further to the present passport with an anti-counterfeit ID chip, the ID chip(s) is embedded in any appropriate sheet other than the front and back covers of the passport body.

According to the present passport with an anti-counterfeit ID chip, the ID chip(s) is embedded in the surface of the passport body having a photograph printed thereon.

According further to the present passport with an anti-counterfeit ID chip, the ID chip (s) is embedded in the center portion, the rim portion or the corner portion on the front or back cover of the passport body.

According even further to the present passport with an anti-counterfeit ID chip, the ID chip (s) is embedded in the center portion, the rim portion or the corner portion on the appropriate sheet other than the front and back covers of the passport body.

### BRIEF DESCRIPTION OF THE DRAWINGS

FIG. 1 is a perspective view showing the passport with the anti-counterfeit ID chip according to the first embodiment of the present invention;

FIG. 2 is a front view showing the passport with the anti-counterfeit ID chip according to the first embodiment of the present invention;

FIG. 3 is a front view showing the passport with the anti-counterfeit ID chip according to the second embodiment of the present invention;

FIG. 4 is a back view showing the passport with the anti-counterfeit ID chip according to the third embodiment of the present invention;

FIG. 5 is a back view showing the passport with the anti-counterfeit ID chip according to the fourth embodiment of the present invention;

FIG. 6 is a front view of the passport with the anti-counterfeit ID chip according to the fifth embodiment of the present invention shown in an opened state; and

FIG. 7 is a front view of the passport with the anti-counterfeit ID chip according to the sixth embodiment of the present invention shown in an opened state.

### DETAILED DESCRIPTION OF THE PREFERRED EMBODIMENT

We will now explain in detail the preferred embodiments of the present invention with reference to the accompanied drawings.

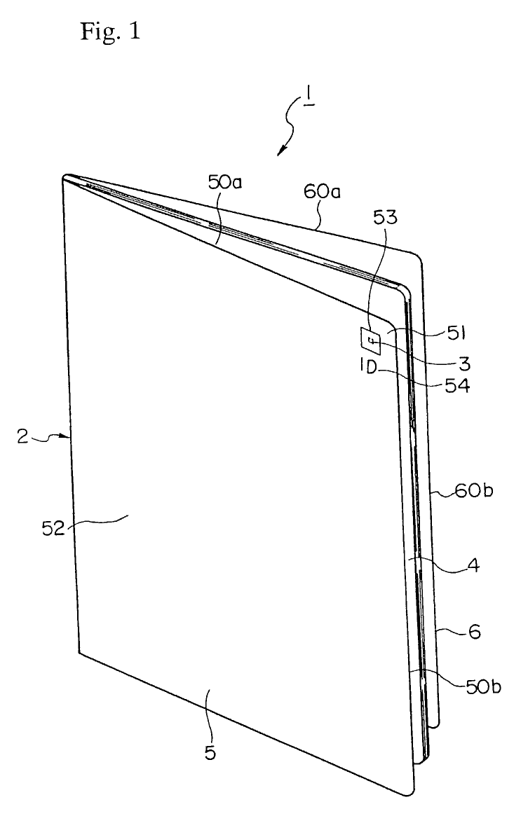

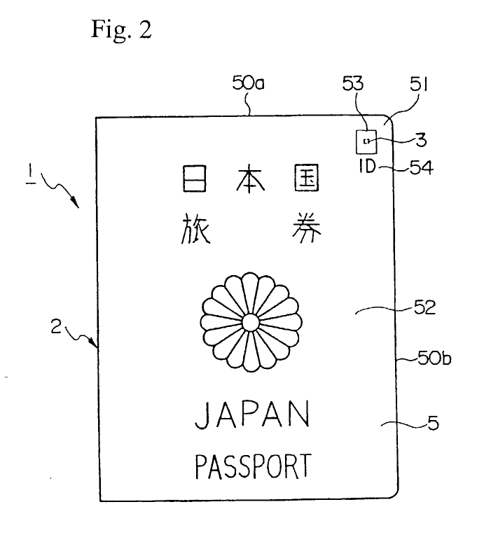

FIG. 1 is a perspective view showing the passport with an anti-counterfeit ID chip according to the first embodiment of the present invention, and FIG. 2 is a front view of the passport with an anti-counterfeit ID chip according to the first embodiment of the invention.

The passport 1 with an anti-counterfeit ID chip according to the present invention comprises, as shown in FIG. 1, a passport body 2 for certifying the identity and the nationality of a traveler traveling to a foreign country, and an ID chip 3 as small as a particle (micro ID chip) recording the passport ID data and embedded in the passport body 2.

As shown in FIG. 1, the passport body 2 of the passport 1 with an anti-counterfeit ID chip comprises plural sheets of paper 4 having the same size, a front cover 5 and a back cover 6, which are assembled to form a booklet.

As shown in FIGS. 1 and 2, in the front cover 5 of the passport body 2 is embedded a single ID chip 3, located at the corner portion 51 where the upper rim 50a and one side rim 50b meet.

As shown in FIG. 2, on the front side surface 52 of the front cover 5 of the passport body 2 is printed a mark 54 indicating that an ID chip 3 is embedded therein.

Further, on the front side surface 52 of the front cover 5 of the passport body 2 is printed a mark 53 indicating where the ID chip 3 is embedded.

The ID chip 3 embedded in the passport body 2 comprises a micro IC (integrated circuit) chip, the micro IC chip being capable of recording a number having 38 digits at maximum.

The size of the ID chip 3 is 0.4×0.4 mm with a thickness of 0.06 mm. Even if the passport 1 is bent, the embedded ID chip will not be damaged. The ID chip is equipped with a 128-bit ROM (read only memory).

The passport 1 with the anti-counterfeit ID chip of the present invention stores in the ID chip 3 the passport ID data including the passport holder's nationality, name, sex, registered domicile, birthday, height, current address, contact address, hair color, eye color, supplementary information, issue date of passport, expiration date of passport, passport number, and so on.

The passport 1 with the anti-counterfeit ID chip according to the invention can have one or more ID chips 3 embedded therein.

The passport 1 with the anti-counterfeit ID chip according to the invention can have the ID chip(s) embedded either in the front cover 5 or the back cover 6 of the passport 2.

The passport 1 with the anti-counterfeit ID chip according to the invention can also have the ID chip(s) embedded in any appropriate sheet 4 other than the front and back covers of the passport 2.

In one example, the passport 1 with the ID chip has the ID chip(s) 3 embedded in the page having the photograph printed thereon.

In another example, the passport 1 with the ID chip has the ID chip(s) 3 embedded either in the center portion, the rim portion or the corner portion of the front cover 5 or back cover 6 of the passport body 2.

In yet another example, the passport 1 with the ID chip has the ID chip(s) 3 embedded either in the center portion, the rim portion or the corner portion of the appropriate sheet 4 other than the front and back covers of the passport 2.

Next, we will explain how the passport 1 with the anti-counterfeit ID chip according to the present invention is used.

At first, the traveler traveling to a foreign country goes to an international airport from which the airplane departs taking the passport 1 with the anti-counterfeit ID chip, and presents the passport 1 at the embarkation/disembarkation check gate of the airport. The embarkation/disembarkation officer at the embarkation check gate of the airport checks whether or not the passport holder is truly the authenticated passport owner by visually observing the personal information, passport information, photograph etc. printed on the passport 1 with the anti-counterfeit ID chip.

Further, the officer at the embarkation check gate can use a dedicated ID chip reader to read the passport ID data recorded in the ID chip 3 embedded in the front cover 5 of the passport body 2 of the passport 1 with the ID chip, in order to display the passport ID data such as the passport holder's nationality, name, sex, registered domicile, birthday, height, current address, contact address, hair color, eye color, supplementary information, purpose of travel, issue date of passport, expiration date of passport, passport number, etc. on a screen.

The officer at the embarkation/disembarkation check gate can further visually observe the passport ID data such as the passport holder's nationality, name, sex, registered domicile, birthday, height, current address, contact address, hair color, eye color, supplementary information, issue date of passport, expiration date of passport, passport number, etc. recorded in the ID chip 3 and displayed on the screen in order to determine whether the passport is a counterfeit passport or not. According to the present passport with the ID chip, the officer at the gate can check with high accuracy whether the passport is a counterfeit passport or not, thus securely cracking down on illegal embarkation or disembarkation at the check gate of the airport.

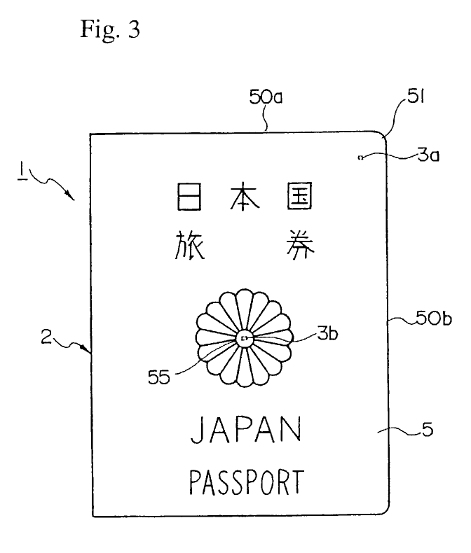

On the front cover 5 of the passport body 2 of the passport 1 with the anti-counterfeit ID chip comprises, as shown in FIG. 3, a micro ID chip 3a and a micro ID chip 3b having stored thereto the passport ID data, embedded in the corner portion 51 where the upper rim 50a and one side rim 50b come into contact and in the center portion 55, respectively.

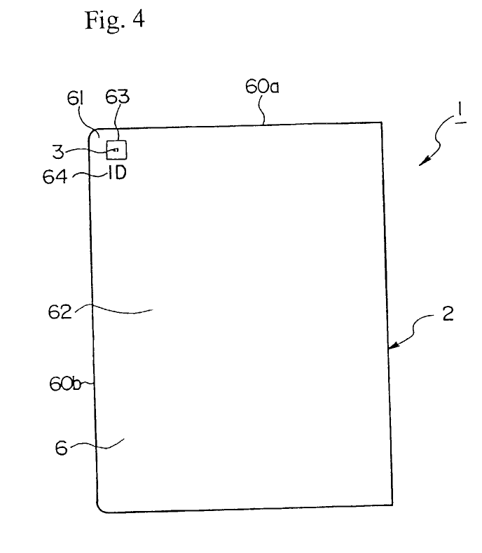

FIG. 4 is a back view of the passport with an anti-counterfeit ID chip according to the third embodiment of the present invention.

In the back cover 6 of the passport 1 with the ID chip is embedded one micro ID chip 3 recording the passport ID data at the corner portion 61 where the upper rim 60a and one side rim 60b meet, as shown in FIG. 4.

On the back surface 62 of the back cover 6 of the passport 1 with the ID chip is printed a mark 64 indicating that an ID chip 3 is embedded therein, as shown in FIG. 4.

Moreover, on the back surface 62 of the back cover 6 of the passport 1 with the ID chip is printed a mark indicating where the ID chip 3 is embedded, as shown in FIG. 4.

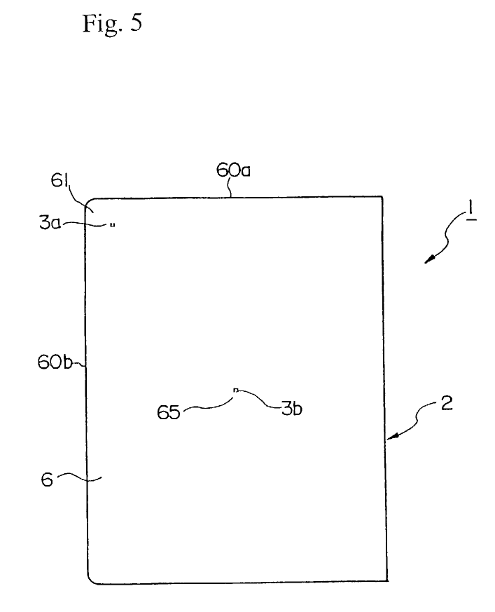

FIG. 5 is a back view showing the passport with the anti-counterfeit ID chip according to the fourth embodiment of the present invention.

In the back cover 6 of the passport 1 with the ID chip are embedded a micro ID chip 3a and a micro ID chip 3b recording the passport ID data which are located at the corner portion 61 where the upper rim 60a and one side rim 60b meet and at the center portion 65, respectively, as shown in FIG. 5.

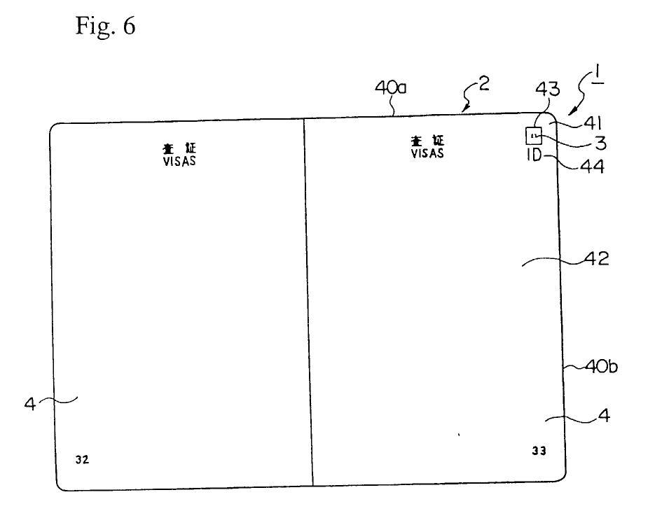

FIG. 6 is a front view of the passport with the anti-counterfeit ID chip according to the fifth embodiment of the invention shown in an opened state.

In an appropriate sheet 4 disposed between the front cover 5 and the back cover 6 of the passport 1 is embedded a micro ID chip 3 recording passport information located at the corner portion 41 where the upper rim 40a and one side rim 40b meet, as shown in FIG. 6.

On one surface 42 of the sheet 4 arranged between the front cover 5 and the back cover 6 of the passport 1 is printed a mark 44 indicating that an ID chip 3 is embedded therein, as shown in FIG. 6.

Further, on the surface 42 of the sheet 4 is printed a mark 43 indicating where the ID chip 3 is embedded, as shown in FIG. 6.

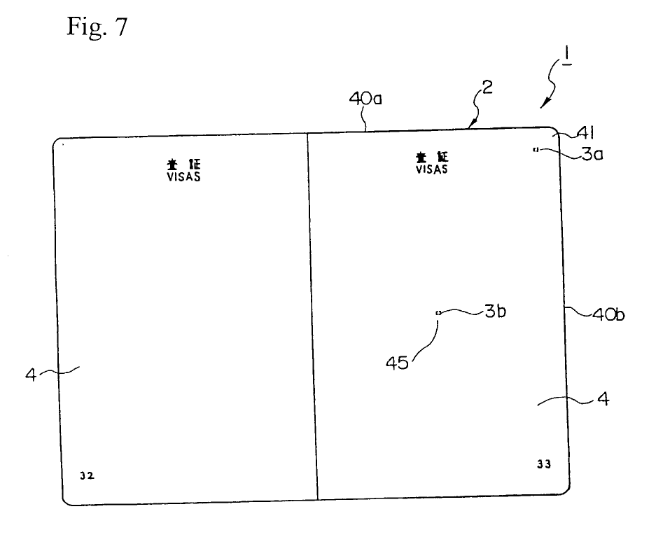

FIG. 7 is a front view of the passport with the anti-counterfeit ID chip according to the sixth embodiment of the present invention shown in an opened state.

In an appropriate sheet 4 disposed between the front cover 5 and the back cover 6 of the passport body 2 are embedded micro ID chips 3 recording passport information, which are located at the corner portion 41 where the upper rim 40a and one side rim 40b meet, and at the center portion 45, as shown in FIG. 7.

As explained, the passport with an anti-counterfeit ID chip of the present invention comprises a micro ID chip embedded into a passport, the ID chip being capable of storing various passport ID data. The ID chip being embedded in the passport will not break even when the passport is bent, and the memory capacity of the ID chip is large, enabling the ID chip to record sufficient passport ID data. By simply embedding the micro ID chip in the passport, counterfeit of the passport can be effectively prevented. The present passport with the anti-counterfeit ID chip can be manufactured easily, enabling the present passport to be produced in large quantities. Since the present micro ID chip is smaller than a rice grain, there is required no special space in the passport to embed the chip. The passport ID data recorded in the ID chip can be read by a dedicated ID chip reader and displayed on a screen, thus enabling the officer at the embarkation/disembarkation check gate to visually observe the passport ID data read out from the ID chip and displayed on the screen in addition to the information conventionally printed on the passport such as the personal information, the passport information, the photograph etc. of the passport owner, based on which the officer can easily determine whether the passport is a counterfeit passport or not. According to the present passport with the anti-counterfeit ID chip, officers at the airport check gate can check with high accuracy whether a passport is a counterfeit passport or not, and the officers are thereby enabled to clamp down on illegal embarkation/disembarkation without fail at the airport check gate.

According to the present passport with an anti-counterfeit ID chip, the ID chip records passport ID data including the passport owner's nationality, name, sex, registered domicile, birthday, height, current address, contact address, hair color, eye color, supplementary information, passport issue date, passport expiration date and passport number. Therefore, the passport ID data can be effectively utilized to check the passport holder.

According to the present passport with the anti-counterfeit ID chip, either only one or a plurality of ID chips can be embedded in the passport. Therefore, the number of ID chips embedded in the passport can be selected freely based on need.

According to the present passport with the anti-counterfeit ID chip, the ID chip can be embedded in the front cover or the back cover of the passport. The location of the ID chip on the front cover or back cover can be selected freely.

According to another variation of the present passport with the anti-counterfeit ID chip, the ID chip can be embedded in any appropriate sheet other than the front and back covers. The location of the ID chip on the appropriate sheet can be selected freely.

According to yet another variation of the invention, the ID chip can be embedded in the center portion, the rim portion or the corner portion on the front or back cover of the passport, the location being selected to the most appropriate area.

According to another variation of the invention, the ID chip can be embedded in the center portion, the rim portion or the corner portion on the appropriate sheet of the passport other than the front and back covers, the location being selected to the most appropriate area.

What is claimed is:

1. A passport with an anti-counterfeit ID chip for certifying the identity and nationality of a passport owner traveling to and returning from a foreign country, the passport comprising:
a passport body; and
one or more micro ID chips storing passport ID data embedded in the passport body.

2. A passport with an anti-counterfeit ID chip according to claim 1, wherein the passport ID data stored in the ID chip includes the passport owner's nationality, name, sex, registered domicile, birthday, height, current address, contact address, hair color, eye color, supplementary information, passport issue date, passport expiration date, and passport number.

3. A passport with an anti-counterfeit ID chip according to claim 1, wherein the number of ID chips embedded in the passport body can be one or more than one.

4. A passport with an anti-counterfeit ID chip according to claim 1, wherein the ID chip(s) is embedded in either the front cover or the back cover of the passport body.

5. A passport with an anti-counterfeit ID chip according to claim 1, wherein the ID chip(s) is embedded in any appropriate sheet other than the front and back covers of the passport body.

6. A passport with an anti-counterfeit ID chip according to claim 1, wherein the ID chip(s) is embedded in the surface of a sheet within the passport body having a photograph printed thereon.

7. A passport with an anti-counterfeit ID chip according to claim 1, wherein the ID chip(s) is embedded in the center portion, the rim portion or the corner portion on the front or back cover of the passport body.

8. A passport with an anti-counterfeit ID chip according to claim 1, wherein the ID chip(s) is embedded in the center portion, the rim portion or the corner portion on the appropriate sheet other than the front and back covers of the passport body.
